(19) United States
(12) Patent Application Publication
(10) Pub. No.: US 2015/0220846 A1
(43) Pub. Date: Aug. 6, 2015

(54) PROCESS CONVERSION DIFFERENCE PREDICTION DEVICE, PROCESS CONVERSION DIFFERENCE PREDICTION METHOD, AND NON-TRANSITORY COMPUTER-READABLE RECORDING MEDIUM CONTAINING A PROCESS CONVERSION DIFFERENCE PREDICTION PROGRAM

(71) Applicant: Kabushiki Kaisha Toshiba, Minato-ku (JP)

(72) Inventors: Ai INOUE, Yokohama-shi (JP); Minoru Inomoto, Yokohama-shi (JP); Kazuyuki Masukawa, Yokohama-shi (JP); Koutarou Sho, Yokkaichi-shi (JP); Seiro Miyoshi, Yokkaichi-shi (JP); Satoshi Usui, Nagoya-shi (JP)

(73) Assignee: Kabushiki Kaisha Toshiba, Minato-ku (JP)

(21) Appl. No.: 14/288,523

(22) Filed: May 28, 2014

(30) Foreign Application Priority Data
Feb. 4, 2014 (JP) 2014-019020

(51) Int. Cl. G06N 5/04; G06F 17/50

(52) U.S. Cl. CPC G06N 5/047; G06F 17/50

(57) ABSTRACT

According to one embodiment, a process conversion difference in a processed pattern having undergone a process via the resist pattern can be predicted, based on results of simulation of a cross-sectional shape of the resist pattern by which predicted values of resist dimensions adapted to a relationship between a parameter for lithography and actual measurement values of the resist dimensions.

### CROSS-REFERENCE TO RELATED APPLICATIONS

This application is based upon and claims the benefit of priority from Japanese Patent Application No. 2014-019020, filed on Feb. 4, 2014; the entire contents of which are incorporated herein by reference.

### FIELD

Embodiments described herein relate generally to process conversion difference prediction devices, process conversion difference prediction methods, and non-transitory computer-readable recording medium containing a process conversion difference prediction programs.

### BACKGROUND

In recent years, with advanced miniaturization of semiconductor devices, resist patterns for use in lithography process have been made finer. This makes it difficult to reproduce a processed pattern on a wafer in accordance with a designed pattern, which may cause a process conversion difference between the dimensions of the processed pattern and the dimensions of the resist pattern.

### BRIEF DESCRIPTION OF THE DRAWINGS

FIG. 1A is a schematic block diagram of a process conversion difference prediction device according to a first embodiment and its peripheral devices, FIG. 1B is a schematic cross-sectional view of an exposure apparatus in which the process conversion difference prediction device illustrated in FIG. 1A is used, FIG. 1C is a cross-sectional diagram illustrating a process after formation of a resist pattern, FIG. 1D is a plane view of the resist pattern illustrated in FIG. 1C on actual measurement of resist dimensions, FIG. 1E is a cross-sectional diagram illustrating a process after formation of a processed pattern, FIG. 1F is a plane view of the processed pattern illustrated in FIG. 1E on actual measurement of dimensions of the processed pattern, FIG. 1G is a diagram illustrating results of simulation of a cross-sectional shape of the resist pattern illustrated in FIG. 1C, FIG. 1H is a diagram illustrating results of simulation of a plane shape of the resist pattern illustrated in FIG. 1C, and FIG. 1I is a diagram illustrating one example of a mask data pattern created at a mask data creation unit 13.

FIG. 2A is a diagram illustrating a relationship between resist dimensions and processed dimensions obtained by actual measurement, FIG. 2B is a plane view of a resist pattern on actual measurement of the resist dimensions, FIG. 2C is a cross-sectional view of a cross-sectional shape of the resist pattern at a measurement point PA illustrated in FIG. 2A, and FIG. 2D is a cross-sectional view of a cross-sectional shape of the resist pattern at a measurement point PB illustrated in FIG. 2A;

FIG. 3 is a diagram illustrating an overview of a method for fitting resist dimensions for use in process conversion difference prediction according to the first embodiment;

FIG. 4 is a diagram illustrating a relationship between resist dimensions and processed dimensions obtained by simulation;

FIG. 5 is a flowchart of a process conversion difference prediction method according to the first embodiment;

FIG. 6 is a diagram illustrating a specific example of a method for fitting resist dimensions for use in process conversion difference prediction according to the first embodiment;

FIG. 7 is a block diagram illustrating a hardware configuration of the process conversion difference prediction device illustrated in FIG. 1; and

FIG. 8 is a diagram illustrating a relationship between resist dimensions and taper angles at each depth along resist film thickness for use in process conversion difference prediction according to a second embodiment.

### DETAILED DESCRIPTION

According to one embodiment, a process conversion difference in a processed pattern having undergone a process via the resist pattern can be predicted, based on results of simulation of a cross-sectional shape of the resist pattern by which predicted values of resist dimensions adapted to a relationship between a parameter for lithography and actual measurement values of the resist dimensions.

Exemplary embodiments of a process conversion difference prediction device and a process conversion difference prediction method will be explained below in detail with reference to the accompanying drawings. The present invention is not limited to the following embodiments.

### First Embodiment

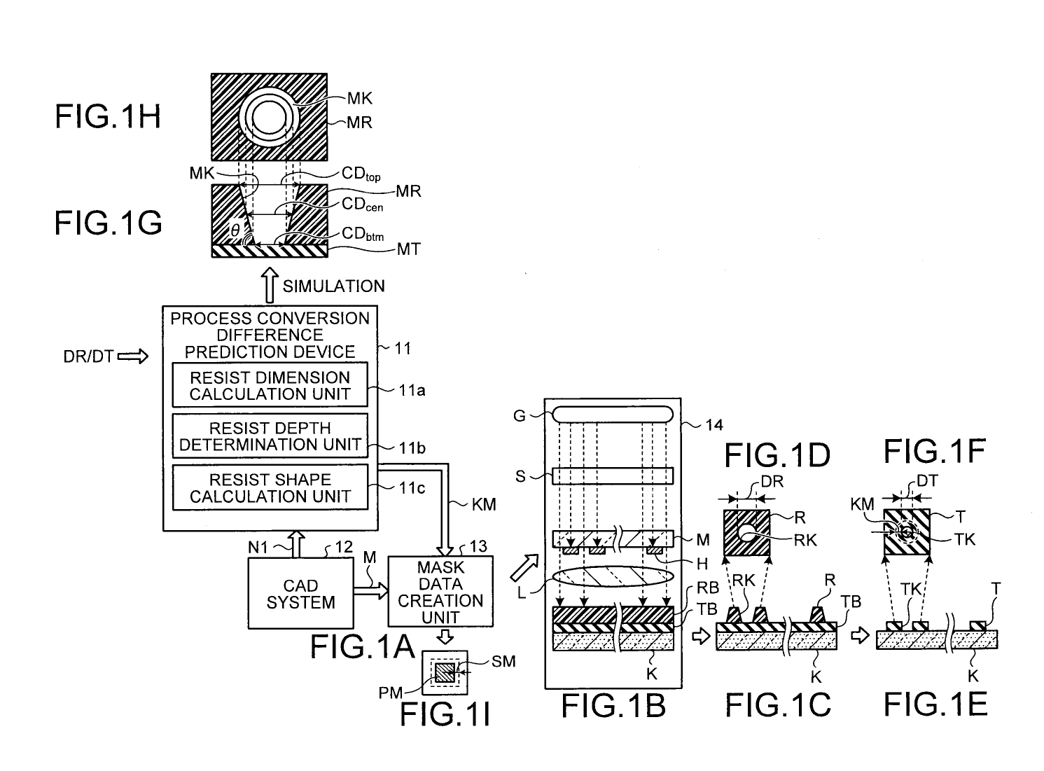

FIG. 1A is a schematic block diagram of a process conversion difference prediction device according to a first embodiment and its peripheral devices, FIG. 1B is a schematic cross-sectional view of an exposure apparatus in which the process conversion difference prediction device illustrated in FIG. 1A is used, FIG. 1C is a cross-sectional diagram illustrating a process after formation of a resist pattern, FIG. 1D is a plane view of the resist pattern illustrated in FIG. 1C on actual measurement of resist dimensions, FIG. 1E is a cross-sectional diagram illustrating a process after formation of a processed pattern, FIG. 1F is a plane view of the processed pattern illustrated in FIG. 1E on actual measurement of dimensions of the processed pattern, FIG. 1G is a diagram illustrating results of simulation of a cross-sectional shape of the resist pattern illustrated in FIG. 1C, FIG. 1H is a diagram illustrating results of simulation of a plane shape of the resist pattern illustrated in FIG. 1C, and FIG. 1I is a diagram illustrating one example of a mask data pattern created at a mask data creation unit 13.

Referring to FIG. 1A, a process conversion difference prediction device 11 is configured to predict a process conversion difference KM in a processed pattern T having undergone a process via a resist pattern R, based on results of simulation of a cross-sectional shape of a resist pattern MR by which predicted values CDₙ of resist dimensions adapted to a relationship between a parameter for lithography and actual measurement values of the resist dimensions. Here, the process conversion difference prediction device 11 includes a resist dimension calculation unit 11a, a resist depth determination unit 11b, and a resist shape calculation unit 11c. Peripheral devices of the process conversion difference prediction device 11 include a CAD system 12 and a mask data creation unit 13. Referring to FIG. 1B, an exposure apparatus 14 includes a light source G, a diaphragm S, a photomask M, and a lens L.

The resist dimension calculation unit 11a calculates by simulation a relationship between a parameter for lithography and predicted values CDₙ of resist dimensions. The parameter for lithography may be selected as parameter that can be varied to change a taper angle of a cross-sectional shape of the resist pattern R. For example, the parameter for lithography may be selected from at least one of exposure amount, focus, mask size, mask pattern position, resolution auxiliary pattern size, and resolution auxiliary pattern position. Alternatively, the parameter for lithography may be a shape of illumination for exposure, or size or position of an assist pattern added to the photomask M. The predicted values CDₙ of the resist dimensions may be determined at each depth of the resist pattern MR. For example, as the predicted values CDₙ of the resist dimensions, a predicted value CDₜₒₚ of the resist dimensions at the top of an opening MK of the resist pattern MR, a predicted value CD_{cen} of the resist dimensions at the center of the same, and a predicted value CD_{btm} of the resist dimensions at the bottom of the same, may be determined. The resist depth determination unit lib determines the predicted values CDₙ of the resist dimensions at the depth along the resist film thickness adapted to the relationship between the parameter for lithography and the actual measurement values DR of the resist dimensions, based on results of the simulation of the cross-sectional shape of the resist pattern MR. The resist shape calculation unit 11c calculates the cross-sectional shape of the resist pattern MR based on the results of the simulation of the cross-sectional shape of the resist pattern MR. The cross-sectional shape of the resist pattern MR may include a taper angle θ of the cross-sectional shape of the resist pattern MR.

Then, the CAD system 12 creates designed layout data N1 for a semiconductor integrated circuit and sends the same to the process conversion difference prediction device 11 and the mask data creation unit 13. Then, the mask data creation unit 13 creates mask data corresponding to a layout pattern specified by the designed layout data N1. The mask data may indicate a mask data pattern PM as illustrated in FIG. 1I, for example. A mask pattern H corresponding to the mask data pattern PM created at the mask data creation unit 13 is formed on the photomask M by a light-shielding film.

Meanwhile, as illustrated in FIG. 1B, a processed film TB is formed on a foundation layer K, and a resist film RB is applied to the processed film TB. The foundation layer K and the processed film TB may be semiconductor substrates, or insulating films such as silicon dioxide films or silicon nitride films, or semiconductor films of amorphous silicon, polycrystalline silicon, or the like, or metal films of Al, Cu, or the like.

Exposure light such as ultraviolet light is emitted from the light source G, narrowed by the diaphragm S, and entered into the resist film RB via the photomask M and the lens L, whereby the resist film RB is exposed.

Next, as illustrated in FIGS. 1C and 1D, after the exposure of the resist film RB, the resist film RB is developed to form a resist pattern R corresponding to the mask pattern H on the photomask M. In the example of FIGS. 1C and 1D, the opening RK is formed as the resist pattern R.

Next, as illustrated in FIGS. 1E and 1F, the processed film TB is processed with as a mask the resist pattern R to which the mask pattern H is transferred, thereby to form the processed pattern T corresponding to the mask pattern H on the photomask M. At that time, the opening TK is formed as the processed pattern T. The process performed on the processed film TB may be etching or ion implantation.

Then, to predict a process conversion difference at the process conversion difference prediction device 11, the actual measurement values DR of the resist dimensions of the resist pattern R and the actual measurement values DT of the dimensions of the processed pattern T are prepared. That is, focus is changed at exposure of the resist film RB. Then, each time focus is changed, the formation of the resist pattern R and the processed pattern T is repeated, and the actual measurement values DR of the resist dimensions of the resist pattern R and the actual measurement values DT of the dimensions of the processed pattern are measured by CD-SEM. Then, the actual measurement values DR of the resist dimensions of the resist pattern R and the actual measurement values DT of the dimensions of the processed pattern T measured each time focus is changed, are input into the process conversion difference prediction device 11.

In addition, when the process conversion difference is predicted at the process conversion difference prediction device 11, the actual processed film TB, a virtual processed film MT corresponding to the resist pattern R, and the resist pattern MR are simulated on a computer. Here, simulation of the resist pattern MR makes it possible to reproduce the cross-sectional shape of the resist pattern MR, and calculate the predicted values CDₙ of the resist dimensions at each depth along the resist film thickness. Specifically, as illustrated in FIG. 1D, when the actual measurement values DR of the resist dimensions of the resist pattern R are measured by CD-SEM, it is not possible to specify the depth along the resist film thickness. Meanwhile, by simulating the resist pattern MR, it is possible to determine the predicted value CDₜₒₚ of the resist dimensions at the top, the predicted value CD_{cen} of the resist dimensions at the center, and the predicted value CD_{btm} of the resist dimensions at the bottom, for example.

Then, the resist dimension calculation unit 11a calculates by simulation a relationship between the focus and the predicted values CDₙ of the resist dimensions at each depth of the resist pattern MR. Then, the resist depth determination unit lib determines the predicted values CDₙ of the resist dimensions at the depth along the resist film thickness adapted to the relationship between the focus and the actual measurement values DR of the resist dimensions. For example, the actual measurement values DR of the resist dimensions with changes in focus are compared to the predicted values CDₜₒₚ, CD_{cen}, and CD_{btm} of the resist dimensions. Then, it is determined what of the predicted values CDₜₒₚ, CD_{cen}, and CD_{btm} of the resist dimensions are closest to the tendency of changes in the actual measurement values DR of the resist dimensions with changes in focus. In addition, the resist shape calculation unit 11c calculates the taper angle θ at which the predicted values CDₙ of the resist dimensions closest to the tendency of changes in the actual measurement values DR of the resist dimensions with changes in focus.

Then, the process conversion difference prediction device 11 predicts the process conversion difference KM in the processed pattern T with reference to the actual measurement values DT of the processed pattern T based on the predicted values CDₙ of the resist dimensions and the taper angle θ closest to the tendency of changes in the actual measurement values DR of the resist dimensions with changes in focus. The process conversion difference KM can be obtained as a difference between the predicted values CDₙ of the resist dimensions and the actual measurement values DT of the dimensions of the processed pattern T. Then, upon receipt of the process conversion difference KM from the process conversion difference prediction device 11, the mask data creation unit 13 calculates a mask correction amount SM based on the process conversion difference KM to correct the dimensions of the mask data pattern PM.

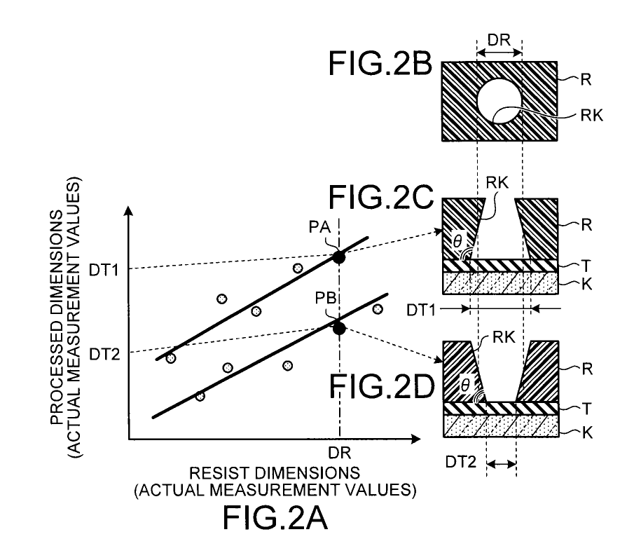

FIG. 2A is a diagram illustrating a relationship between resist dimensions and processed dimensions obtained by actual measurement, FIG. 2B is a plane view of a resist pattern on actual measurement of the resist dimensions, FIG. 2C is a cross-sectional view of a cross-sectional shape of the resist pattern at a measurement point PA illustrated in FIG. 2A, and FIG. 2D is a cross-sectional view of a cross-sectional shape of the resist pattern at a measurement point PB illustrated in FIG. 2A.

Referring to FIG. 2B, the plane shape of the resist pattern R is measured by CD-SEM to obtain the actual measurement values DR of the resist dimensions. Thus, as illustrated in FIG. 2A, even in the case where the actual measurement values DR of the resist dimensions are equal, different actual measurement values DT1 and DT2 are obtained as actual measurement values DT of the dimensions of the processed pattern T. This is because, even in the case where the actual measurement values DR of the resist dimensions are equal, when the cross-sectional shapes of the resist pattern R are different in taper angle θ and the like, the dimensions of the processed pattern T are different. It is thus necessary to take into account the cross-sectional shape with the taper angle θ and the like of the resist pattern R to specify the actual measurement values DT of the dimensions of the processed pattern T. However, the cross-sectional shape with the taper angle θ and the like of the resist pattern R cannot be actually measured from the plane shape of the resist pattern R. Accordingly, the cross-sectional shape with the taper angle 9 and the like of the resist pattern R is predicted by simulating the cross-sectional shape of the resist pattern R.

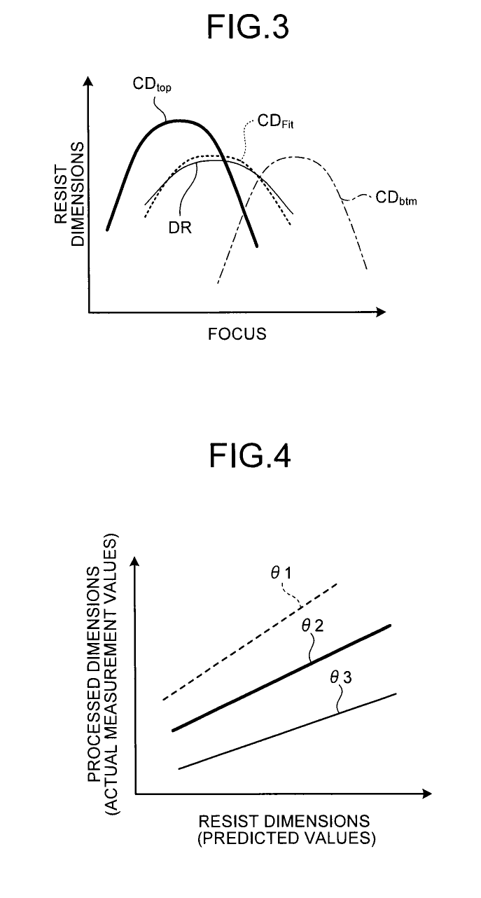

FIG. 3 is a diagram illustrating an overview of a method for fitting resist dimensions for use in process conversion difference prediction according to the first embodiment.

Referring to FIG. 3, the predicted values CDₙ of the resist dimensions with changes in focus are calculated by simulation at each depth of the resist pattern MR. Then, predicted values CD_{Fit} of the resist dimensions closest to the tendency of changes in the actual measurement values DR of the resist dimensions with changes in focus are determined. When the predicted values CD_{Fit} of the resist dimensions are determined, it is possible to calculate by simulation the taper angles θ at which the predicted values CD_{Fit} can be obtained.

FIG. 4 is a diagram illustrating a relationship between resist dimensions and processed dimensions obtained by simulation.

Referring to FIG. 4, even in the case where the predicted values CDₙ of the resist dimensions are equal, it is possible to obtain different processed dimensions according to taper angles θ1 to θ3 in the cross-sectional shape of the resist pattern MR.

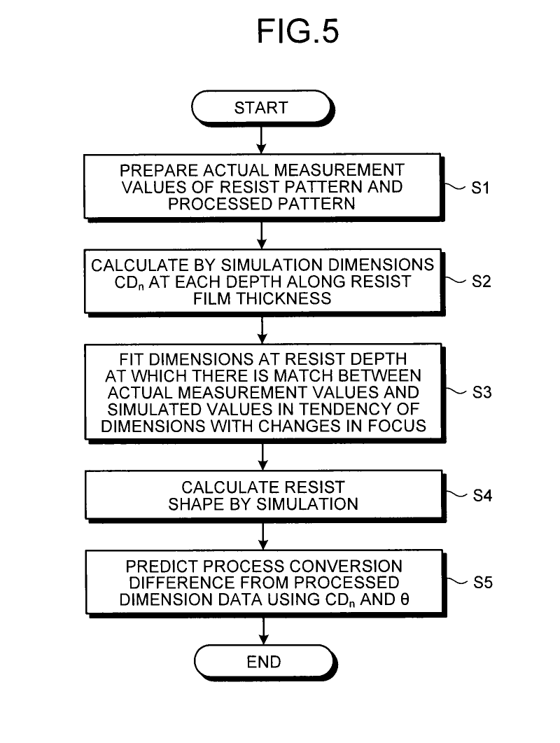

FIG. 5 is a flowchart of a process conversion difference prediction method according to the first embodiment.

Referring to FIG. 5, to predict the process conversion difference at the process conversion difference prediction device 11, FEM exposure verification is carried out. Then, the formation of the resist pattern R and the processed pattern T is repeated each time the focus is changed, and the actual measurement values DR of the resist dimensions of the resist pattern R and the actual measurement values DT of the dimensions of the processed pattern T are measured by CD-SEM (S1).

Next, the predicted values CDₙ of the resist dimensions with changes in focus are calculated by simulation at each depth of the resist pattern MR (S2). Then, the predicted values CDₙ of the resist dimensions at the depth along the resist film thickness close to the tendency of changes in the actual measurement values DR of the resist dimensions with changes in focus are determined (S3). Then, the taper angle θ at which the predicted values CDₙ of the resist dimensions closest to the tendency of changes in the actual measurement values DR of the resist dimensions with changes in focus is calculated (S4). Then, the process conversion difference KM of the processed pattern T is predicted with reference to the actual measurement values DT of the dimensions in the processed pattern T based on the predicted values CDₙ of the resist dimensions and the taper angle θ closest to the tendency of changes in the actual measurement values DR of the resist dimensions with changes in focus (S5).

Here, by simulating the cross-sectional shape of the resist pattern R after exposure, it is possible to specify the actual measurement values DT of the dimensions of the processed pattern T corresponding to the taper angle of the cross-sectional shape of the resist pattern R. Accordingly, even when there are variations in the actual measurement values DT of the dimensions of the processed pattern T according to the taper angle of the cross-sectional shape of the resist pattern R although the actual measurement values DR of the resist dimensions are equal, it is possible to improve the accuracy of prediction of the process conversion difference KM.

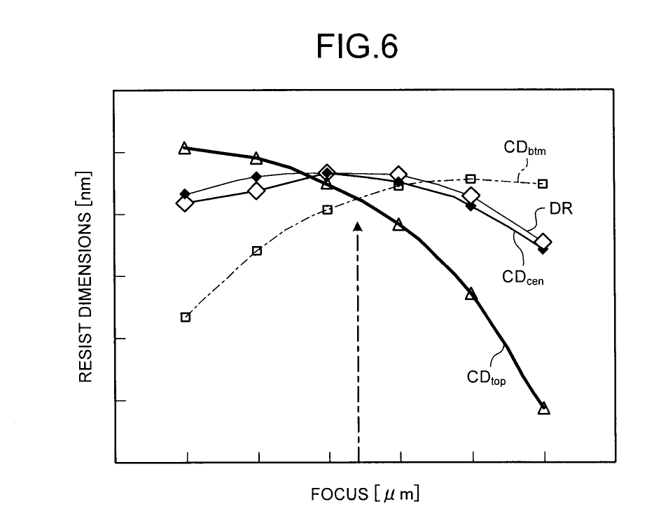

FIG. 6 is a diagram illustrating a specific example of a method for fitting resist dimensions for use in process conversion difference prediction according to the first embodiment. In the example of FIG. 6, the predicted values CDₜₒₚ, CD_{cen}, and CD_{btm} of the resist dimensions with changes in focus are provided.

Referring to FIG. 6, the predicted values CDₜₒₚ, CD_{cen}, and CD_{btm} of the resist dimensions with changes in focus are calculated by simulation. For example, it can be determined that the predicted value CD_{cen} of the resist dimensions with changes in focus is closest to the tendency of changes in the actual measurement values DR. Then, when the predicted value CD_{cen} of the resist dimensions is determined, it is possible to calculate by simulation the taper angle θ at which the predicted value CD_{cen} can be obtained. Then, it is possible to specify the resist dimensions at a best-focus position BF from the predicted value CD_{cen} of the resist dimensions, and determine the processed dimensions from the resist dimensions and the taper angle θ, for example. At that time, as illustrated in FIG. 4, the processed dimensions can be uniquely determined by specifying the resist dimensions and the taper angle θ.

In the foregoing embodiment, focus is taken as an example of a parameter for lithography. Alternatively, the parameter for lithography may be exposure amount, mask size, illumination shape, or the like.

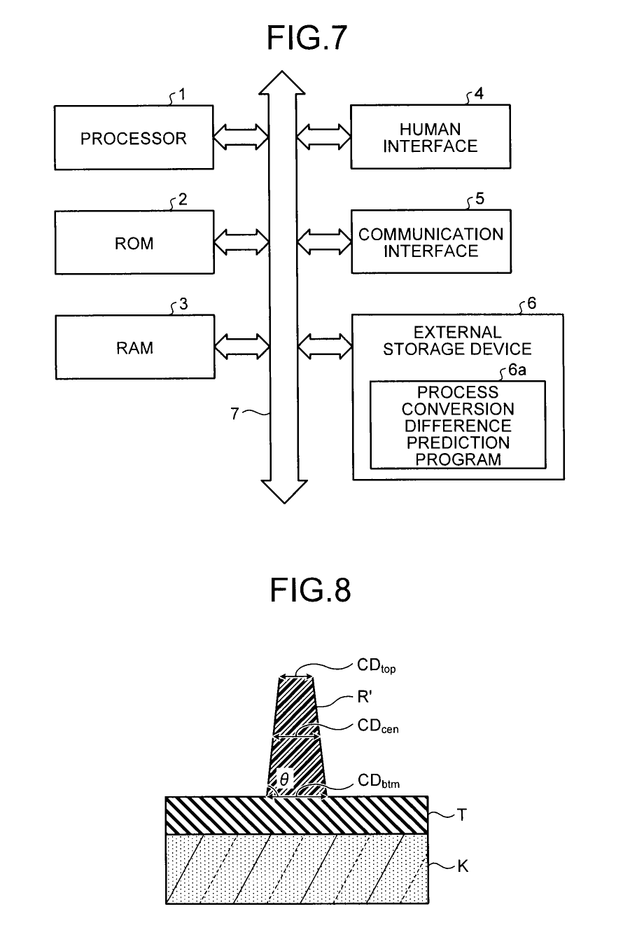

FIG. 7 is a block diagram illustrating a hardware configuration of the process conversion difference prediction device illustrated in FIG. 1.

Referring to FIG. 7, the process conversion difference prediction device 11 may include a processor 1 including a CPU and the like, a ROM 2 that stores fixed data, a RAM 3 that provides a work area and the like to the processor 1, a human interface 4 that mediates between a user and a computer, a communication interface 5 that provides means for communications with the outside, and an external storage device 6 that stores programs and various data for operating the processor 1. The processor 1, the ROM 2, the RAM 3, the human interface 4, the communication interface 5, and the external storage device 6 are connected together via a bus 7.

The external storage device 6 may be a magnetic disc such as a hard disc, an optical disc such as a DVD, a mobile semiconductor storage device such as a USB memory or a memory card, or the like, for example. The human interface 4 may be a keyboard, a mouse, or a touch panel as an input interface, and may be a display, a printer, or the like as an output interface, for example. The communication interface 5 may be a LAN card, a modem, a router, or the like for connection with the Internet, a LAN, or the like, for example. The external storage device 6 has installed therein a process conversion difference prediction program 6a for predicting a process conversion difference in a processed pattern having undergone a process via a resist pattern.

When the process conversion difference prediction program 6a is executed at the processor 1, the cross-sectional shape of the resist pattern by which the predicted values of the resist dimensions adapted to the relationship between the parameter for lithography and the actual measurement values of the resist dimensions is simulated, and the process conversion difference in the processed pattern is predicted based on results of the simulation.

The process conversion difference prediction program 6a to be executed at the processor 1 may be stored in advance in the external storage device 6 and then read into the RAM 3 at execution of the program, or may be stored in advance in the ROM 2, or may be acquired via the communication interface 5. In addition, the process conversion difference prediction program 6a may be executed on a standalone computer or on a crowd computer.

### Second Embodiment

FIG. 9 is a diagram illustrating a relationship between resist dimensions and taper angles at each depth along resist film thickness for use in process conversion difference prediction according to a second embodiment.

Referring to FIG. 9, in the foregoing first embodiment, the opening is formed as the resist pattern R. Alternatively, the present invention may be applied to a line-shaped resist pattern R′. In this case, it is also possible to improve the accuracy of prediction of the process conversion difference by calculating through simulation the taper angle θ of the cross-sectional shape of the resist pattern R′.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A process conversion difference prediction device, wherein the device configured to predict a process conversion difference in a processed pattern having undergone a process via a resist pattern, based on results of simulation of a cross-sectional shape of the resist pattern by which predicted values of resist dimensions adapted to a relationship between a parameter for lithography and actual measurement values of the resist dimensions are obtained.

2. The process conversion difference prediction device according to claim 1, comprising:
a resist dimension calculation unit that calculates by simulation a relationship between the parameter for lithography and the predicted values of the resist dimensions;
a resist depth determination unit that determines the predicted values of the resist dimensions at a depth along resist film thickness adapted to the relationship between the parameter and the actual measurement values of the resist dimensions, based on results of the simulation of the cross-sectional shape of the resist pattern; and
a resist shape calculation unit that calculates the cross-sectional shape of the resist pattern based on the results of the simulation of the cross-sectional shape of the resist pattern, wherein
the device predicts the process conversion difference in the processed pattern having undergone the process via the resist pattern, based on the predicted values of the resist dimensions and the cross-sectional shape of the resist pattern.

3. The process conversion difference prediction device according to claim 1, wherein the parameter is selected from at least one of exposure amount, focus, mask size, mask pattern position, resolution auxiliary pattern size, and resolution auxiliary pattern position.

4. The process conversion difference prediction device according to claim 1, wherein the cross-sectional shape of the resist pattern indicates a taper angle of the resist pattern.

5. The process conversion difference prediction device according to claim 1, wherein the process conversion difference is a difference between the predicted values of the resist dimensions and the actual measurement values of the dimensions of the processed pattern.

6. The process conversion difference prediction device according to claim 1, wherein
the predicted values of the resist dimensions with changes in the parameter are calculated by simulation at each depth of the resist pattern,
the predicted values of the resist dimensions closest to the tendency of changes in actual measurement values of the resist dimensions with changes in the parameter are determined, and
the cross-sectional shape of the resist pattern by which the predicted values of the resist dimensions are obtained is calculated by simulation.

7. The process conversion difference prediction device according to claim 6, wherein the process conversion difference in the processed pattern is predicted with reference to the actual measurement values of the dimensions of the processed pattern based on the predicted values of the resist dimensions closest to the tendency of changes in the actual measurement values of the resist dimensions with changes in the parameter and the cross-sectional shape of the resist pattern.

8. A process conversion difference prediction method, comprising:
simulating a cross-sectional shape of a resist pattern by which predicted values of resist dimensions adapted to a relationship between a parameter for lithography and actual measurement values of the resist dimensions are obtained; and
predicting a process conversion difference in a processed pattern having undergone a process via the resist pattern, based on results of the simulation of the cross-sectional shape of the resist pattern.

9. The process conversion difference prediction method according to claim 8, further comprising determining the predicted values of the resist dimensions at a depth along resist film thickness adapted to the relationship between the parameter and the actual measurement values of the resist dimensions, based on results of the simulation of the cross-sectional shape of the resist pattern.

10. The process conversion difference prediction method according to claim 8, wherein the parameter is selected from at least one of exposure amount, focus, mask size, mask pattern position, resolution auxiliary pattern size, and resolution auxiliary pattern position.

11. The process conversion difference prediction method according to claim 8, wherein the cross-sectional shape of the resist pattern indicates a taper angle of the resist pattern.

12. The process conversion difference prediction method according to claim 8, wherein the process conversion difference is a difference between the predicted values of the resist dimensions and the actual measurement values of the dimensions of the processed pattern.

13. The process conversion difference prediction method according to claim 8, wherein
the predicted values of the resist dimensions with changes in the parameter are calculated by simulation at each depth of the resist pattern,
the predicted values of the resist dimensions closest to the tendency of changes in actual measurement values of the resist dimensions with changes in the parameter are determined, and
the cross-sectional shape of the resist pattern by which the predicted values of the resist dimensions are obtained is calculated by simulation.

14. The process conversion difference prediction method according to claim 13, wherein the process conversion difference in the processed pattern is predicted with reference to the actual measurement values of the dimensions of the processed pattern based on the predicted values of the resist dimensions closest to the tendency of changes in the actual measurement values of the resist dimensions with changes in the parameter and the cross-sectional shape of the resist pattern.

15. A non-transitory computer-readable recording medium containing a process conversion difference prediction program which cause a computer to perform a process conversion difference prediction method, the method comprising:
simulating a cross-sectional shape of a resist pattern by which predicted values of resist dimensions adapted to a relationship between a parameter for lithography and actual measurement values of the resist dimensions are obtained; and
predicting a process conversion difference in a processed pattern having undergone a process via the resist pattern, based on results of the simulation of the cross-sectional shape of the resist pattern.

16. The non-transitory computer-readable recording medium according to claim 15, wherein the parameter is selected from at least one of exposure amount, focus, mask size, mask pattern position, resolution auxiliary pattern size, and resolution auxiliary pattern position.

17. The non-transitory computer-readable recording medium according to claim 15, wherein the cross-sectional shape of the resist pattern indicates a taper angle of the resist pattern.

18. The non-transitory computer-readable recording medium according to claim 15, wherein the process conversion difference is a difference between the predicted values of the resist dimensions and the actual measurement values of the dimensions of the processed pattern.

19. The non-transitory computer-readable recording medium according to claim 15, wherein
the predicted values of the resist dimensions with changes in the parameter are calculated by simulation at each depth of the resist pattern,
the predicted values of the resist dimensions closest to the tendency of changes in actual measurement values of the resist dimensions with changes in the parameter are determined, and
the cross-sectional shape of the resist pattern by which the predicted values of the resist dimensions are obtained is calculated by simulation.

20. The non-transitory computer-readable recording medium according to claim 19, wherein the process conversion difference in the processed pattern is predicted with reference to the actual measurement values of the dimensions of the processed pattern based on the predicted values of the resist dimensions closest to the tendency of changes in the actual measurement values of the resist dimensions with changes in the parameter and the cross-sectional shape of the resist pattern.
